(19) United States
(12) Patent Application Publication
(10) Pub. No.: US 2023/0398497 A1
(43) Pub. Date: Dec. 14, 2023

(54) FILTER HOUSING PROVIDED WITH MEMBRANE FILTER RODS

(71) Applicant: Norwegian Recycling Services AS, STAVANGER (NO)

(72) Inventor: Trond Berge Aarestrup, STAVANGER (NO)

(73) Assignee: Norwegian Recycling Services AS, STAVANGER (NO)

(21) Appl. No.: 18/034,117

(22) PCT Filed: Nov. 1, 2021
(86) PCT No.: PCT/NO2021/050227

§ 371 Date: Apr. 27, 2023

(30) Foreign Application Priority Data
Oct. 30, 2020 (NO) 20201186

(51) Int. Cl. B01D 63/04; B01D 65/02

(52) U.S. Cl. CPC B01D 63/046; B01D 65/02; B01D 2313/025; B01D 2321/04

(57) ABSTRACT

A filter housing has an inlet end with an inlet for a feed liquid and an outlet end with an outlet for the feed liquid; an inlet for a permeate; an outlet for the permeate; an inlet for flushing liquid; and a holding device forming an inlet end and an outlet end for membrane filter rods oriented parallel to an axis. The filter housing has an internal perforated plate oriented perpendicular to the axis and positioned between the inlet end and the outlet end. The plate is has first through holes for the membrane filter rods and second through holes interspersed with the first through holes. The plate divides the filter housing into first and second internal compartments. A method is for filtering a main fluid in a filter housing to achieve an approximate uniform transmembrane pressure along the membrane filter rods.

### CROSS-REFERENCE TO RELATED APPLICATIONS

This application is the U.S. national stage application of International Application PCT/NO2021/050227, filed Nov. 1, 2021, which international application was published on May 2, 2022, as International Publication WO 2022/093040 in the English language. The International Application claims priority of Norwegian Patent Application No. 20201186, filed Oct. 30, 2020. The international application and Norwegian application are both incorporated herein by reference, in entirety

### FIELD

This invention concerns a filter housing for a plurality of membrane filter rods. The membrane filter rods have one or several longitudinal channels, and the membrane layer is positioned on the wall/surface of the channels with a permeable support matrix underneath. The membrane filter rods may comprise a ceramic matrix which forms and supports the longitudinal channels. More particularly the invention concerns an improved filter housing where a condition of approximate uniform transmembrane pressure (UTMP) is achieved without filling the free space inside the filter housing with restriction materials. The invention further concerns an improved back flushing operation compared to prior art. The back flushing operation exposes the membrane filter rods to a more even back flushing irrespective of the location of the rod within the filter housing and to an even back flushing along the surface of the rod from one end portion to the opposite end portion.

### BACKGROUND

Optimum operation of membrane filter rods of the ceramic type requires that the pressure drop along the outside of membrane filter rod from the inlet portion towards the outlet portion equals the pressure drop inside the membrane filter rod. Thereby the pressure difference, the transmembrane pressure, over the membrane filter rod is similar from the inlet end to the outlet end. The pressure on the outside of the membrane filter rods is less than the pressure on the inside to allow for a flow of permeate from the inside to the outside. The membrane surface inside the rods should preferably be operated at an optimal trans membrane pressure. If the trans membrane pressure is too high, the membranes become overloaded, and particles build up on the membrane and clog the membrane. If the trans membrane pressure is too low, the capacity of the membrane is not exploited. It is known to fill the space inside the filter housing on the permeate side with a flow restriction material. Thereby a more optimal transmembrane pressure is achieved along the length of the membrane filter rod.

The membrane filter rods may be cleaned periodically by back flushing to regain flux. A flushing liquid, which may be the permeate, is guided to the filter housing at a higher pressure than the pressure within the channels of the membrane filter rods. Flushing liquid or permeate will then penetrate through the membrane wall from the permeate side and to the membrane channels inside the membrane filter rod. Deposits will be lifted off from the membrane wall and the deposits are brought back to the retentate flow. However, if the flow and/or the pressure of the flushing liquid is not even from membrane filter rod to membrane filter rod, and/or along the surface and length of the membrane filter rods, the cleaning becomes uneven. Restriction material within the filter housing restricts the flow of flushing liquid as well, and the restriction material thereby contributes to an uneven cleaning of the membrane filter rods.

Restriction material within the filter housing may also cause problems for operation and service due to operational degradation, or loss of restriction material, and servicing may be challenging in order to remove and replace membrane filter rods.

Membrane filter rods of the ceramic type are stiff and fragile. Such membrane filter rods will be destroyed if bended. Therefore, membrane filter rods of the ceramic type are handled with care during transportation through a supply chain, during mounting in a filter house and during operation and maintenance.

### SUMMARY

The invention has for its object to or remedy or to reduce at least one of the drawbacks of the prior art, or at least provide an improvement or a useful alternative to prior art.

The object is achieved through features, which are specified in the description below and in the claims that follow.

The invention is defined by the independent patent claims. The dependent claims define advantageous embodiments of the invention.

In a first aspect the invention relates more particularly to a filter housing for membrane filter rods. The filter housing forms a longitudinal axis and comprises:
an inlet end comprising an inlet for a feed liquid and an outlet end comprising an outlet for the feed liquid;
an inlet for a permeate at the inlet end;
an outlet for permeate at the outlet end;
an inlet for a flushing liquid; and
a holding device forming an inlet end (71) and an outlet end (79) for a plurality of membrane filter rods oriented parallel along the longitudinal axis.

The filter housing is provided with at least one internal perforated plate oriented perpendicular to the longitudinal axis and positioned between the inlet end and the outlet end, said plate is provided with a plurality of first through holes for the plurality of membrane filter rods and a plurality of second through holes interspersed with the first through holes, and the plate divides the filter housing into a first internal compartment and a second internal compartment. The feed liquid is mostly the same as a retentate leaving the end of the membrane filter rod. The second through holes act as flow restriction holes for the permeate that fills the filter housing. The permeate flows from the inlet end towards the outlet end of the filter housing. The membrane layer separates the retentate from the permeate and is thus the border between the channels filled with feed liquid/retentate and the permeate side in the filter housing.

The membrane filter rods may be of the ceramic type, i.e. the membrane layer is positioned on the wall/surface of the channels with a permeable support matrix underneath.

The restriction holes may be distributed over the face of the plate. The restriction holes may be distributed evenly over the face of the plate. The restriction holes may be distributed symmetrically around the longitudinal axis.

Each of the first internal compartment and the second internal compartment may be provided with an inlet for the flushing liquid. In an alternative embodiment the number of inlets for the flushing liquid may be less than the number of internal compartments. In an alternative embodiment the number of inlets for the flushing liquid may be larger than the number of internal compartments.

The filter housing may comprise a modified perforated plate provided with at least one flushing hole. The flushing hole may comprise a check valve. Thereby flushing liquid may flow through the perforated plate from a side facing the outlet end and towards a side facing the inlet end.

In a second aspect the invention relates more particularly to a method for filtering a main fluid in a filter housing comprising a filter assembly with a plurality of membrane filter rods. The filter housing comprises at least one inlet for a flushing liquid. The method comprises to divide the filter housing into at least a first internal compartment and a second internal compartment by inserting a perforated plate provided with a plurality of first through holes for the plurality of membrane filter rods and a plurality of second through holes interspersed with the first through holes into the filter housing.

The method achieves an approximate uniform transmembrane pressure (UTMP) along the membrane filter rods positioned inside the filter housing.

The membrane filter rods may be of the ceramic type, i.e. the membrane layer is positioned on the wall/surface of the channels with a permeable support matrix underneath.

The restriction holes may be distributed over the face of the plate. The restriction holes may be distributed evenly over the face of the plate. The restriction holes may be distributed symmetrically around the longitudinal axis.

The method may comprise to provide the filter housing with a number of inlets for the flushing liquid that is larger than the number of perforated plates. The method may comprise to provide the filter housing with a number of inlets for the flushing liquid that is less than the number of perforated plates. The method may comprise to provide the filter housing with a number of inlets for the flushing liquid that corresponds with the number of perforated plates.

### BRIEF DESCRIPTION OF THE DRAWINGS

In the following is described examples of preferred embodiments illustrated in the accompanying drawings, wherein:

FIG. 1 shows schematically a membrane filter assembly according to prior art;

FIG. 2 shows a side view of a filter housing according to the invention;

FIG. 3 shows in the same scale as FIG. 2, a top view of the filter housing;

FIG. 4 shows in another scale, schematically in a perspective view a holding device for membrane filter rods in one embodiment; and

FIG. 5 shows schematically a membrane filter assembly according to the invention, in an alternative embodiment.

### DETAILED DESCRIPTION OF THE DRAWINGS

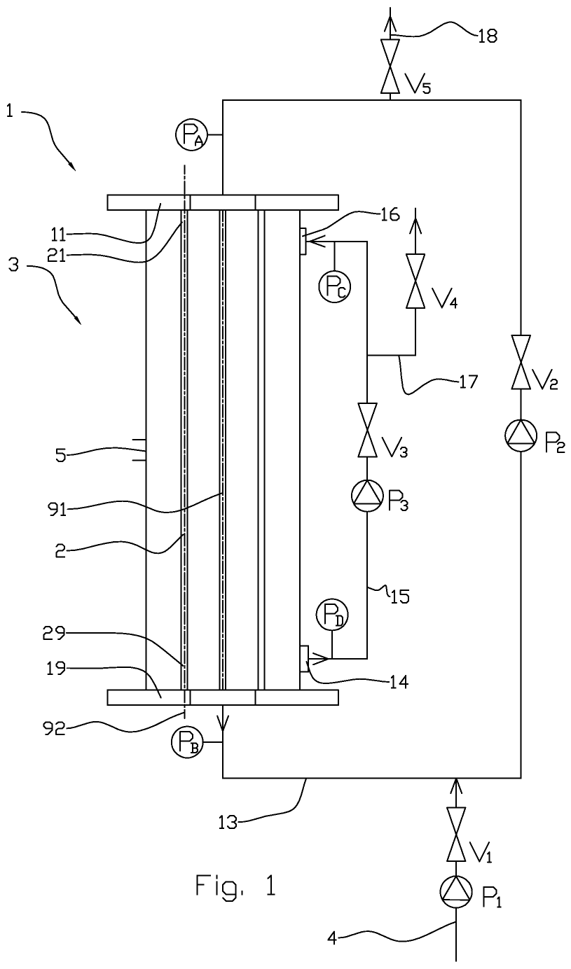

Prior art will be described with reference to FIG. 1. In the drawings, the reference numeral 1 indicates a filter housing. A plurality of membrane filter rods 2 are positioned within the filter housing 1 and form a filter assembly 3. The filter housing 1 forms a longitudinal axis 91. The membrane filter rods 2 form a longitudinal axis 92 which is parallel to the longitudinal axis 91. The filter housing 1 forms an inlet end 11 and an opposite outlet end 19. A circulation conduit 13 connects an outlet at the outlet end 19 with an inlet at the inlet end 11.

The main fluid, which may be water comprising particles or a second liquid such as oil, is fed into the filter assembly 3 through the inlet conduit 4 by means of a feeding pump P₁. The particles and/or the second liquid is to be separated from a main fluid in the filter assembly 3. The main fluid is fed into the circulation conduit 13 and enters the membrane filter rods 2 via the inlet at the inlet end 11. Liquid, retentate, that does not pass through a membrane wall (not shown) of the membrane filter rod 2 leaves the filter housing 1 through the outlet at the outlet end 19 where the retentate enters the circulation conduit 13 and is circulated back to the inlet end 11. Liquid that has passed through the membrane walls of the membrane filter rods 2, the permeate, leaves the filter housing 1 through a permeate outlet 14 at the outlet end 19 and enters a permeate conduit 15.

Permeate is circulated back to the filter housing 1 through a permeate inlet 16 at the inlet end 11.

Produced permeate is bled off from the permeate conduit 15 through a permeate bleed line 17.

The main fluid becomes more concentrated as permeate is filtered off. Main fluid may be continuously bled off or intermittently removed from the circulation conduit 13 through a drain line 18. The rate is determined by a valve V₅. Input for controlling the valve V₅ may be a fixed ratio between main fluid fed into the circulation conduit 13 and produced permeate, or a monitored concentration of particles/second liquid in the retentate.

The feeding rate of main fluid into the circulation conduit 13 is controlled by a valve V₁. The pressure within the circulation conduit 13 is determined by the pump P₁ and the valve V₁. A valve V₄ on the bleed line 17 determines the pressure within the permeate conduit 15.

A pump P₂ circulates the fluid in the circulation conduit 13, and a valve V₂ or other device may assist in regulation of fluid circulation rate.

The membrane filter rods 2 comprise a ceramic matrix which forms and supports longitudinal channels. Each membrane filter rod 2 comprises one or a plurality of internal membrane channels (not shown). A typical number of channels may be twenty-three within each membrane filter rod 2. The membrane filter rod 2 forms in cross section a rim portion (not shown) where no channels are located, and an active portion where the channels are located. The membrane channels form a longitudinal axis that is parallel to the longitudinal axis 92 of the membrane filter rod 2. The membrane channels are lined with the membrane, hereafter termed the membrane wall. Due to a pressure difference over the membrane wall, decreasing from the inlet end 21 of the membrane filter rod 2 towards the outlet end 29 of the membrane filter rod 2, liquid, the permeate, flows out from the membrane filter rod 2 through the membrane wall. The main fluid passes through the membrane channels. Due to friction and the resulting turbulence, the main fluid at least partly cleans the internal membrane channels for deposits. Flux (litre/m²/hour; [LMH]) of permeate may then be maintained in a stable manner in a continuous process.

The membrane filter rods 2 may be cleaned periodically by back flushing to regain loss of flux rate. A flushing liquid, which may be the permeate, is guided to the filter housing 1 at a higher pressure than the pressure in the circulation conduit 13. Permeate will then penetrate through the membrane wall from the outside and to the membrane channels inside the membrane filter rod 2. Deposit will be lifted off from the membrane wall and the deposit is brought back to the retentate flow.

Within the membrane filter rods 2 there is a pressure drop from the inlet end 21, P_{A}, and the outlet end 29, P_{B}, due to friction. The pressure drop (ΔP=P_{B}−P_{A}) will change with the flow velocity of the main fluid. Flux may be increased by increasing the pressure drop ΔP. The pressure drop ΔP may be increased by regulation of the pump P₂ and/or the valve V₂. Increased pressure drop ΔP may improve filtration conditions at the surface of the membrane channels. However, this must be balanced with some negative effects which may come into consideration such as higher energy consumption of the filtration process, faster erosion of the surface of the membrane channels due to particles, unfavourable sized particles entering the membrane wall and/or membrane surface, and unfavourable pressure conditions along the length of the membrane filter rods 2.

In a filtration assembly 3 where there is no pressure drop ΔP within the filter housing 1 along the outside of the membrane filter rods, i.e. the pressure P_{D} at the permeate outlet 14 close to equals the pressure P_{C} at the permeate inlet 16, there are unfavourable conditions for membrane filtration. As an example, a filtration process operates at an optimum of 0.7 barg trans membrane pressure (TMP) to achieve a stable flux over time. P_{A} is set to barg, P B is set to 4 barg and P_{C}=P_{D}=3.8 barg. At the inlet end 21, the TMP will be 1.2 barg, and at the outlet end 29 the TMP will be 0.2 barg. Only at the middle portion of the membrane filter rods 2 will the TMP be in the optimal range of 0.7 barg. The inlet portion of the membrane filter rod 2 is overloaded and will too rapid be clogged while the filtration potential of the outlet portion of the membrane filter rod 2 is not exploited.

It is known to operate the process in a filter assembly of this kind as a uniform transmembrane pressure (UTMP) system to avoid the partly unfavourable pressure conditions over the length of the membrane filter rods 2. This may be achieved by a pressure drop ΔP that is similar on the outside and the inside of the membrane filter rods 2 over the length of the membrane filter rods, i.e. P_{A}−P_{B}=P_{C}−P_{D}. If there are no restrictions on the permeate side within the filter housing 1, a pump P₃ on the permeate conduit 15 may run at high speed or have a large capacity to achieve the necessary pressure drop ΔP between P_{D} and P_{C}. A larger pump P₃ is more expensive and running a pump at high capacity consumes energy. It is known to fill the filter housing 1 with a restriction material (not shown) to solve the problem of high flow rate at the permeate side. The restriction material may be a granulate. When the filter housing 1 is filled with a granulate, there is an approximately continuous pressure drop along the membrane filter rods 2. The process is then operating at UTMP with a smaller pump P₃ and with reduced energy consumption.

The filter housing 1 may have one separate back flushing inlet 5. As an alternative the permeate flow may be reversed at a higher pressure. The restriction material causes a pressure drop in the flushing liquid from the back-flushing inlet 5 towards the outer surface of the membrane filter rods 2. The membrane filter rods 2 are positioned at different distances from the back-flushing inlet 5, and the distance along the outer surface of the membrane filter rods 2 varies to the flushing inlet 5. Thereby the membrane filter rods 2 and the portions of the membrane filter rods 2 that are closest to the back-flushing inlet 5 receive the main portion of the flushing liquid. Membrane filter rods 2 and portions of the membrane filter rods 2 at a far distance from the back-flushing inlet 5 are not backflushed in an effective manner.

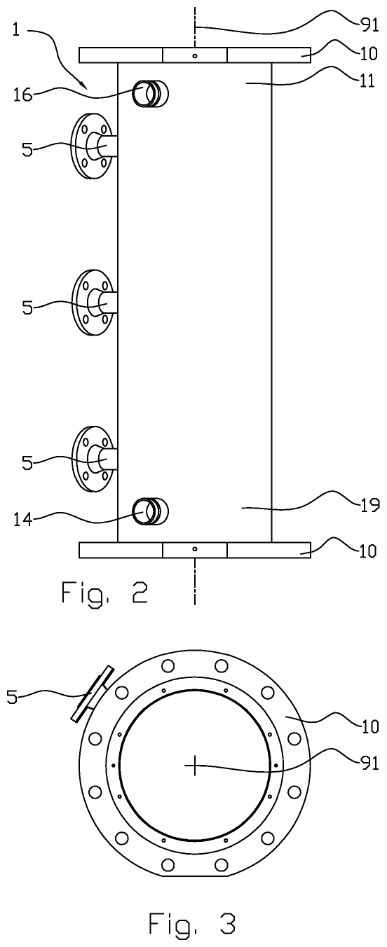

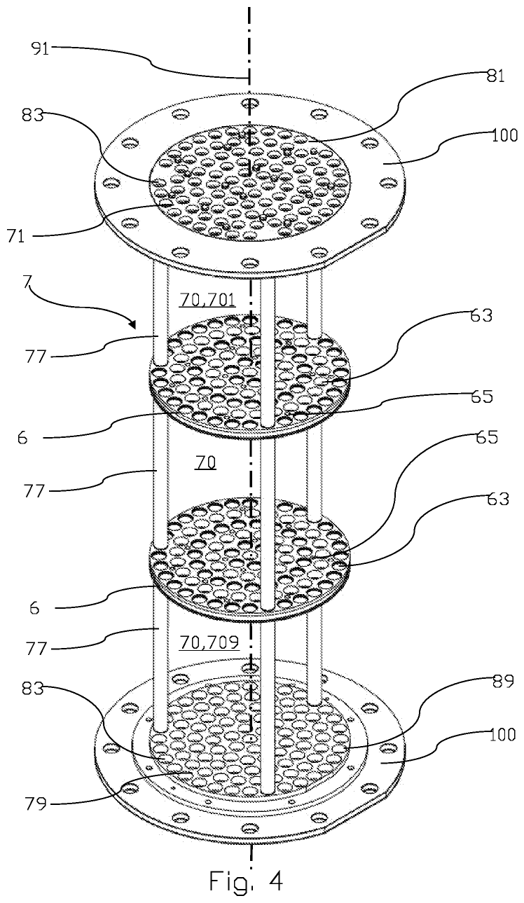

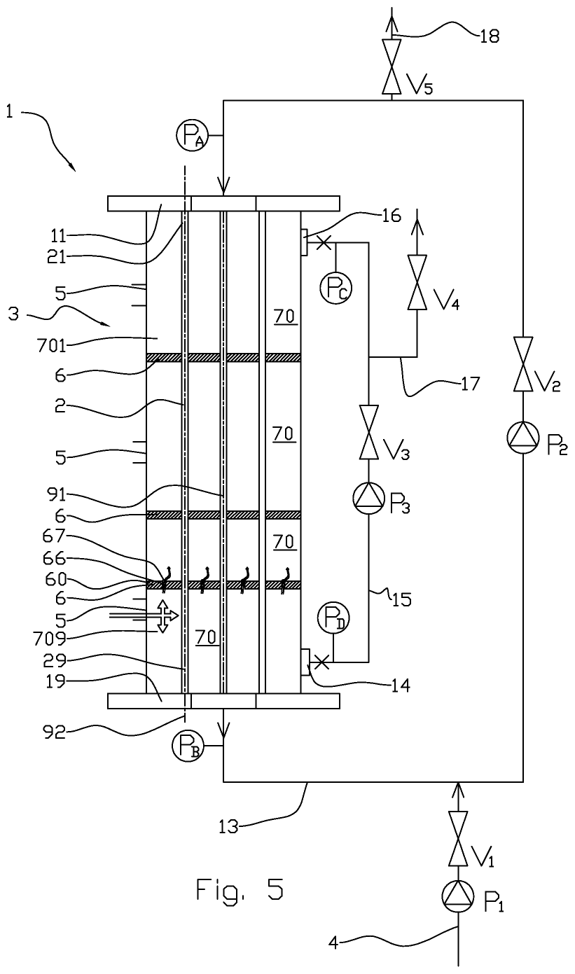

The invention is described with reference to FIGS. 2 to 5. In one described embodiment the invention is shown with two internal perforated plates 6. The invention is not limited to this embodiment. In one embodiment there may be only one internal perforated plate 6. In other embodiments there may be more than two internal perforated plates 6, such as three internal perforated plates 6 as shown in FIG. 5, or more than three internal perforated plates 6.

As shown in FIG. 2, the invention comprises of a filter housing 1. The filter housing 1 forms a longitudinal axis 91. The filter housing 1 forms an inlet end 11 and an opposite outlet end 19. The inlet end 11 and the outlet end 19 is provided with flanges 10 for connection to the circulation conduit 13 which is not shown in FIGS. 2 to 4. The filter housing 1 is provided with a permeate outlet 14 at the outlet end 19 and a permeate inlet 16 at the inlet end 11. A permeate conduit 15 (not shown in FIGS. 2-4) connects the permeate outlet 14 with the permeate inlet 16.

FIG. 4 shows a holding device 7 for membrane filter rods 2. The holding device 7 is positioned within the filter housing 1. The holding device 7 forms an inlet end 71 and an outlet end 79. The inlet end 71 and the outlet end 79 each comprises a flange 100 which connects to the flange 10. The inlet end 71 comprises a first perforated holding disc 81. The first holding disc 81 is provided with through holes 83. Each through hole 83 corresponds with the active portion of the membrane filter rod 2. The inlet end 21 of the membrane filter rod 2 abuts the first holding disc 81 in a sealing manner at the rim portion. The outlet end 79 comprises a second perforated holding disc 89. The second holding disc 89 is provided with through holes 83. Each through hole 83 corresponds with the active portion of the membrane filter rod 2. The outlet end 29 of the membrane filter rod 2 abuts the second holding disc 89 in a sealing manner at the rim portion.

FIG. 4 shows the holding device 7 in an embodiment with two perforated plates 6. Each plate 6 is positioned between the first holding disc 81 and the second holding disc 89. The holding device 7 comprises spacers 77 that keep the perforated plates 6 in a fixed position in the holding device 7. The plates 6 are oriented perpendicular to the longitudinal axis 91. Each plate 6 is provided with a plurality of first through holes 63. The diameter of the first through hole 63 corresponds with the external diameter of the membrane filter rod 2. Each plate 6 is provided with a plurality of second through holes 65, hereafter termed restriction holes 65. The number of first through holes 63 correspond with the number of through holes 83 in the first holding disc 81 and the second holding disc 89. The through holes 63 and through holes 83 are aligned. Thereby a membrane filter rod 2 abuts the holding discs 81, 89 and are supported by the perforated plates 6.

The restriction holes 65 are interspersed with the first through holes 63. The restriction holes 65 are distributed over the face of the plate 6. The restriction holes 65 may in one embodiment be distributed symmetrically around the longitudinal axis 91.

The holding device 7 forms compartments 70 within the filter housing 1. The number of compartments 70 equals the number of perforated plates 6 plus one. The filter housing 1 may in one embodiment comprise one back flushing inlet 5 for each compartment 70. In an alternative embodiment the number of back flushing inlets 5 is less than the number of compartments 70. In an alternative embodiment the number of back flushing inlets 5 is larger than the number of compartments 70.

In operation the compartments 70 are filled with permeate. The permeate inlet 16 connects the inlet compartment 701 with the permeate conduit 15. The permeate outlet 14 connects the outlet compartment 709 with the permeate conduit 15. Permeate flows from one compartment 70, 701 to the neighbouring compartment 70, 709 through the restriction holes 65. Only an insignificant quantity of permeate leeks through the trough holes 63 on the outside of the membrane filter rods 2, or between the outside of the perforated plates 6 and the wall of the filter housing 1. Thereby there is a pressure drop in the permeate from the inlet end 11 towards the outlet end 19. The pressure drop may be significant at low flow rates of permeate and can be adjusted by the number of restriction holes 65, the size of the restriction holes 65, running speed of the pump P₃, and the valve V₃. Filling the internal of the filter housing 1 with a restriction material is avoided.

In one embodiment the filter housing 1 comprises two perforated plates 6, which may be positioned at ⅓ of the membrane filter rod length and ⅔ of the membrane filter rod length. Using the same example as above, the filtration process operates at an optimum of 0.7 barg trans membrane pressure (TMP) to achieve a stable flux over time. P_{A} is set to barg, P_{B} is set to 4 barg. The pressure drop inside of the channels are close to linear from membrane filter rod start to end, giving pressures close to 4.66 barg at ⅓ of the length of the membrane filter rod and a pressure 4.33 barg at ⅔ of the membrane filter rod length. P_{C} is adjusted to 4.13 barg and P_{D} is adjusted to 3.47 barg. The number of perforated plates 6 is two. The TMP in the inlet compartment 701 will be 0.87 barg at membrane filter rod start and the TMP in the outlet compartment 709 will be 0.53 barg at membrane filter rod end. This is a substantial improvement compared to a filter housing 1 without restrictions in the flow of permeate. The number of perforated plates 6 may be increased, and the process will approach a UTMP system.

Each compartment 70, 701, 709 may comprise its own flushing inlet 5. At back flushing each membrane filter rod 2 will be flushed with approximately the same amount of flushing liquid at an even pressure due to that compartment 70, 701, 709 does not comprise a restriction material.

The number of perforated plates 6 may exceed the number of flushing inlets 5 as shown in FIG. 5. In one embodiment one of the perforated plates 6 comprises a modified perforated plate 60 provided with at least one flushing hole 66 and the flushing hole 66 comprises a check valve 67. The second through holes 65, which act as flow restriction holes, are not shown in FIG. 5. An advantage with one or more modified perforated plates 60 is that the number of compartments 70 exceeds the number of flushing inlets 5 which allow for a simplified construction. In addition, the filter assembly 3 approaches a full UTMP system while an optimized backflushing of the membrane filter rods 2 are maintained. Backflushing is shown with open arrows in FIG. 5.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A filter housing, said filter housing forms a longitudinal axis and comprises:
an inlet end comprising an inlet for a feed liquid and an outlet end comprising an outlet for the feed liquid;
an inlet for a permeate at the inlet end;
an outlet for the permeate at the outlet end;
an inlet for a flushing liquid; and
a holding device forming an inlet end and an outlet end for a plurality of membrane filter rods oriented parallel along the longitudinal axis,
wherein the filter housing is provided with at least one internal perforated plate oriented perpendicular to the longitudinal axis and positioned between the inlet end and the outlet end, said plate is provided with a plurality of first through holes for the plurality of membrane filter rods and a plurality of second through holes interspersed with the first through holes, and the plate divides the filter housing into a first internal compartment and a second internal compartment.

2. The filter housing according to claim 1, wherein each of the first internal compartment and the second internal compartment is provided with an inlet for the flushing liquid.

3. The filter housing according to claim 1, wherein the number of inlets for the flushing liquid is less than the number of internal compartments.

4. The filter housing according to claim 1, wherein the filter housing comprises a modified perforated plate provided with at least one flushing hole, said flushing hole comprises a check valve.

5. A method for filtering a main fluid in a filter housing comprising a filter assembly with a plurality of membrane filter rods, said filter housing comprises at least one inlet for a flushing liquid, wherein the method comprises to divide the filter housing into at least a first internal compartment and a second internal compartment by inserting a perforated plate provided with a plurality of first through holes for the plurality of membrane filter rods and a plurality of second through holes interspersed with the first through holes, into the filter housing.

6. The method according to claim 5, wherein the method comprises to provide the filter housing with a number of inlets for the flushing liquid that is larger than the number of perforated plates.

7. The method according to claim 5, wherein the method comprises to provide the filter housing with a number of inlets for the flushing liquid that is less than the number of perforated plates.
